(19) United States
(12) Patent Application Publication
(10) Pub. No.: US 2015/0133163 A1
(43) Pub. Date: May 14, 2015

(54) INFORMATION NOTIFICATION METHOD AND INFORMATION NOTIFICATION SYSTEM

(71) Applicant: Panasonic Intellectual Property Corporation of America, Torrance, CA (US)

(72) Inventor: Tomohiko Kitamura, Osaka (JP)

(21) Appl. No.: 14/395,643

(22) PCT Filed: Feb. 14, 2014
(86) PCT No.: PCT/JP2014/000776

§ 371 Date: Oct. 20, 2014

Related U.S. Application Data
(60) Provisional application No. 61/767,408, filed on Feb. 21, 2013.

(51) Int. Cl. H04W 4/02; H04W 24/08

(52) U.S. Cl. CPC H04W 4/021; H04W 24/08
USPC 455/456.3

(57) ABSTRACT

A presence sensing unit (51) uses area information stored in an area information storing unit (1) and position information relating to a subject (3) as sensed by a position information sensing unit (4) to sense whether or not the subject is present in a report area (8) including a monitoring target area (7). An extrapolating unit (52) uses state information and attribute information relating to the subject 3 stored in the state information storing unit (2) to extrapolate an influence of the monitoring target area (7) in the sensed report area (8) on a state of the subject (3). A reporting unit (53) reports information whose content conforms to a result of the extrapolation by the extrapolating unit (52) to the subject (3).

### TECHNICAL FIELD

The present disclosure relates to a technique of reporting information to a terminal apparatus when it is sensed that a subject is present in a specific area.

### BACKGROUND ART

Techniques of monitoring whether or not a subject has entered or exited a specific area using position detecting means which detects a current position of the subject are proposed.

Patent Literature 1 discloses a technique of sensing entry to or exit from a predetermined area and reporting the sensed entry or exit by telephone transmission. Specifically, a current position of a subject is detected and a determination is made as to whether the subject has moved from the detected current position to the inside of a set range set in advance or to the outside of the set range. When it is determined that the subject has moved to the inside of the set range or to the outside of the set range, a call is automatically made to a telephone number of a destination stored in advance, and when the destination's call state is calling, the communication is cut off.

Patent Literature 2 discloses a method and a program for reporting entry to a dangerous area.

Patent Literature 3 discloses an area entry/exit information reporting system and a system server which determines whether a terminal entering an area is a monitoring target terminal and which performs area determination.

However, Patent Literature 1 to 3 described above all entirely disregard the effect of a monitoring target area entered or exited by a subject on a state of the subject. Therefore, further improvements are required in order to report information with content appropriate to such an effect to the subject or the like.

### CITATION LIST

### Patent Literature

Patent Literature 1: Japanese Patent Application Laid-open No. 2002-262354

Patent Literature 2: Japanese Patent No. 5075542

Patent Literature 3: Japanese Patent No. 4911478

### SUMMARY OF INVENTION

An information reporting method according to an aspect of the present disclosure is an information reporting method in an information reporting system which reports information to a terminal apparatus through a network, the information reporting method including: sensing current position information relating to a subject; sensing whether or not the subject is present in a report area including a monitoring target area, using area information in which is registered, in association with one another, position information relating to the monitoring target area and a degree of influence of the monitoring target area on a state of the subject and also using the sensed position information; extrapolating a degree of influence of a monitoring target area in the sensed report area on a state of the subject, using state information indicating a state of the subject stored in a storage apparatus and the degree of influence; and reporting information whose content corresponds to a result of the extrapolation to the terminal apparatus.

### BRIEF DESCRIPTION OF DRAWINGS

FIG. 1 is a diagram showing an example of an overall configuration of an information reporting system according to a first embodiment;

FIG. 2 is a block diagram showing an example of a functional configuration of the information reporting system according to the first embodiment;

FIG. 3 is a flow chart showing an example of a process of the information reporting system according to the first embodiment;

FIG. 4 is a diagram showing an example of data configuration of area information stored by an area information storing unit according to a second embodiment;

FIG. 5 is a diagram showing an example of data configuration of area information stored by an area information storing unit according to a fifth embodiment;

FIG. 6 is a graph used when determining whether a diet state is good or bad according to the second embodiment;

FIG. 7 is a diagram showing an example of a data configuration of a value determining table used when determining a reporting value according to the second embodiment;

FIG. 8 is a diagram showing an example of an overall configuration of an information reporting system according to an eleventh embodiment of the present invention;

FIG. 9 is a diagram showing an example of data configuration of area information according to a fourteenth embodiment; and

FIG. 10 is a diagram showing an example of data configuration of state information according to the fourteenth embodiment.

### DESCRIPTION OF EMBODIMENTS

### Circumstances Leading to an Aspect of the Present Disclosure

In recent years, the popularization of GPS-enabled mobile phones such as smartphones has made it easy to acquire position information relating to a subject. As such, ways of managing activities of the subject using acquired position information and providing cloud services with high added value are being explored.

For example, let us imagine that a user is on a diet. Eating high caloric food such as those provided at a hamburger shop adversely affects a diet state of the user. However, since it is not easy to overcome one's appetite, there may be cases where the user feels too hungry to remember that the user is on a diet and the user ends up finding himself/herself in a hamburger shop eating high caloric food.

Therefore, when a user on a diet is present in a store that may have a negative impact on his/her diet state, it is convenient for the user if a service that prompts the user to exit the store is provided to the user. On the other hand, when a user on a diet approaches a store that is beneficial to his/her diet state, it is convenient for the user if a service that prompts the user to enter the store is provided to the user.

In addition, for example, in a case where a user is saving money, while such a user needs to be prudent in spending money, there may be cases where the user feels a strong urge to purchase a certain product and is unable to resist his/her desire to purchase the same and, before he/she realizes it, the user finds himself/herself in a store that has an ATM and drawing money from his/her bank account. In this case, since the balance of the user's account is reduced, the store with an ATM is detrimental to an account state of the user who is saving money. Therefore, when a user saving money is present in a store that has an ATM, it is convenient for the user if a service that prompts the user to exit the store is provided to the user.

However, Patent Literature 1 to 3 described above all simply monitor whether or not a user has entered a prescribed monitoring target area and do not manage a state of the user. Therefore, when the user is present in a monitoring target area that may influence the state of the user, the user cannot be provided with a service that prompts the user to exit or stay in the monitoring target area.

Meanwhile, in order to realize such a service, when it is sensed that the user has entered a store, some kind of information must be reported to a mobile terminal of the user at least before the user starts eating or withdraws money from the user's account. In other words, information must be transmitted to the mobile terminal of the user with low latency after sensing that the user has entered a store.

In consideration thereof, an object of the present disclosure is to realize, with low latency, a cloud service that reports information to a terminal apparatus of a subject or a third party when it is sensed that a user is present in a location that may influence the state of the subject.

An information reporting method according to an aspect of the present disclosure is an information reporting method in an information reporting system which reports information to a terminal apparatus through a network, the information reporting method including: sensing current position information relating to a subject; sensing whether or not the subject is present in a report area including a monitoring target area, using area information in which is registered, in association with one another, position information relating to the monitoring target area and a degree of influence of the monitoring target area on a state of the subject and also using the sensed position information; extrapolating a degree of influence of a monitoring target area in the sensed report area on a state of the subject, using state information indicating a state of the subject stored in a storage apparatus and the degree of influence; and reporting information whose content corresponds to a result of the extrapolation to the terminal apparatus.

In this case, when it is sensed that the subject is present in a report area including a monitoring target area, the influence of the monitoring target area on a state of the subject is extrapolated and information corresponding to a result of the extrapolation is reported to the terminal apparatus. Therefore, the subject owning the terminal apparatus can be prevented from entering a location detrimental to his/her state and engaging in an activity detrimental to his/her state. Alternatively, the subject can be encouraged to enter a location beneficial to his/her state and engage in an activity beneficial to his/her state. As a result, the state of the subject can be guided to a better state.

In addition, since a determination is made on whether or not the subject is in the report area including the monitoring target area using area information in which position information relating to the monitoring target area and attribute information are registered in advance, whether or not the subject has entered the report area can be quickly sensed and latency from entry to the report area by the subject up to reporting of information can be reduced.

In the aspect described above, an extrapolation may be made as to whether or not a monitoring target area in the sensed report area has a negative influence on a state of the subject, and the reporting may be performed when a determination is made that the subject is not staying in the monitoring target area extrapolated as an area that causes the negative influence.

In this case, even if the subject enters a location that causes a negative influence on the state of the subject, since information is reported when the subject exits the location, the subject can be made aware that he/she has engaged in a favorable activity by reporting, for example, information praising the subject. As a result, motivation of the subject toward improving his/her state can be increased.

Furthermore, in the aspect described above, an extrapolation may be made as to whether or not a monitoring target area in the sensed report area has a negative influence on a state of the subject, and the reporting may be performed when a determination is made that the subject is staying in the monitoring target area extrapolated so as to cause the negative influence.

In this case, since information is reported when the subject enters a location that causes a negative influence on the state of the subject and stays at the location, the subject can be made aware that he/she should exit the location by reporting, for example, a warning to the subject. As a result, deterioration of the state of the subject can be avoided.

In addition, in the aspect described above, when determination is made that the subject has stayed in the monitoring target area extrapolated so as to cause the negative influence, information whose content is varied in accordance with a period of stay may be reported.

In this case, since information whose content is varied in accordance with a period of stay is reported, for example, by reporting information with higher warning severity, the subject can be forced into a situation where the subject has no choice but to exit the location.

Furthermore, in the aspect described above, an extrapolation may be made as to whether or not the monitoring target area in the sensed report area has a positive influence on a state of the subject, and the reporting is performed when a determination may be made that the subject is staying in the monitoring target area extrapolated as an area that causes the positive influence.

In this case, since information is reported when the subject enters a location that causes a positive influence on a state of the subject and stays at the location, the subject can be made aware that he/she should stay at the location by being reported of, for example, information praising the subject. As a result, the state of the subject can be improved.

In addition, in the aspect described above, when determination is made that the subject has stayed in the monitoring target area extrapolated as an area that causes the positive influence, information whose content is modified in accordance with a period of stay may be reported.

In this case, since information whose content is varied in accordance with a period of stay is reported, for example, by reporting information with a higher degree of praise, motivation of the subject to stay at the location and engage in an activity that improves his/her state can be provided.

Furthermore, in the aspect described above, when determination is made that the subject has stayed in the monitoring target area extrapolated as an area that causes the negative influence, information that causes discomfort in the subject may be reported.

In this case, since unpleasant information is reported when the subject stays at a location that causes a negative influence on a state of the subject, the subject can be compelled to exit the location.

In addition, in the aspect described above, when determination is made that the subject has stayed in the monitoring target area extrapolated as an area that causes the negative influence, information that is inappropriate for the monitoring target area may be reported.

In this case, when the subject stays at a location that causes a negative influence on a state of the subject, information that is not appropriate for the location is reported to the subject, the subject can be compelled to exit the location.

Furthermore, in the aspect described above, information for relaying at least one of sound, light, odor, vibration, and heat to the subject may be reported.

In this case, since information on at least one of sound, light, odor, vibration, and heat is relayed to the subject, information that is more stimulating can be reported to the subject.

In addition, in the aspect described above, the reporting may be performed to the terminal apparatus of at least one of the subject and a third party specified in advance.

In this case, information is reported to at least one of the subject and the third party.

Furthermore, in the aspect described above, the terminal apparatus may sense current position information relating to the subject and store the current position information in a storage apparatus, extrapolate an activity range of the subject from the stored position information, acquire area information relating to the monitoring target area included in the extrapolated activity range from a server, and sense whether or not the subject is present in the report area, using the acquired area information.

In this case, since a determination as to whether or not the subject is present in the report area is performed by the terminal apparatus, latency of this process can be lowered. In addition, since the terminal apparatus acquires only the area information relating to a monitoring target area in the activity range of the subject, an amount of consumption of a memory resource of the terminal apparatus can be suppressed. Furthermore, since it is no longer necessary to determine whether or not the subject is present in a monitoring target area outside of the activity range of the subject, the number of process steps can be reduced.

In addition, in the aspect described above, when the terminal apparatus determines that the subject has stayed outside of the activity range based on the sensed position information, the terminal apparatus may acquire the area information relating to the monitoring target area positioned within a certain range including the sensed position information from the server.

In this case, even when the subject stays at a location outside of an activity range, monitoring of the subject can be continued and appropriate reporting can be performed.

Furthermore, in the aspect described above, a size of the report area may be determined based on the area information and the state information.

In this case, a range of the report area can be varied according to a relationship between a state of the subject and a monitoring target area in which the subject stays.

In addition, in the aspect described above, sensing of the position information may be performed using at least one of a GPS signal, access point information of a wireless LAN, and base station information of a mobile phone communication network.

In this case, since a position of the subject is sensed using at least one of a GPS signal, access point information, and base station information, a position of the subject can be reliably acquired.

Furthermore, in the aspect described above, the monitoring target area may be a location where the subject spends money and the state information may be a household financial state of the subject.

In this case, a service for managing the household financial state of the subject can be provided to the subject.

In addition, in the aspect described above, the monitoring target area may be a location that influences a diet state of the subject and the state information may be the diet state of the subject.

In this case, a service for managing the diet state of the subject can be provided to the subject.

Furthermore, in the aspect described above, the state information relating to the subject stored in the storage apparatus may be used to calculate a degree of short-term progress and a degree of long-term progress with respect to the state of the subject relative to a target state, an overall state of the subject may be calculated using the degree of long-term progress and the degree of short-term progress, and a reporting value in accordance with the overall state and the degree of influence may be extrapolated as an influence of the monitoring target area on a state of the subject.

In this case, since an overall state of the subject is calculated in consideration of a degree of short-term progress and a degree of long-term progress, the state of the subject can be calculated with high accuracy. In addition, since a reporting value in accordance with the overall state and the degree of influence is extrapolated as an influence of the monitoring target area on the state of the subject, extrapolation can be performed which not only considers the degree of influence but also considers the overall state of the subject.

Hereinafter, embodiments of the present invention will be described with reference to the drawings.

### First Embodiment

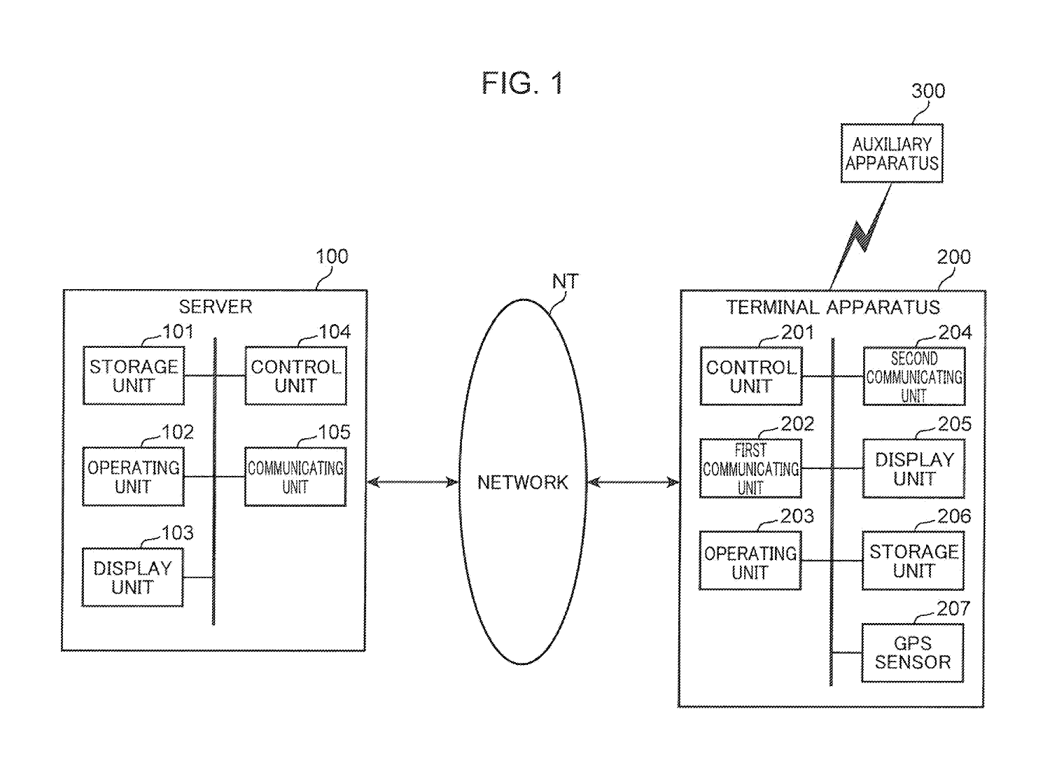

FIG. 1 is a diagram showing an example of an overall configuration of an information reporting system according to a first embodiment. The information reporting system includes a server 100, a terminal apparatus 200, and an auxiliary apparatus 300. The server 100 and the terminal apparatus 200 are connected so as to be capable of communicating with each other via a network NT. As the network NT, for example, a public communication network such as the Internet communication network and a mobile phone communication network can be adopted. Therefore, the server 100 and the terminal apparatus 200 communicate with each other using a communication protocol such as TCP/IP.

The server 100 is, for example, a cloud server constituted by one or more computers. The server 100 includes a storage unit 101, an operating unit 102, a display unit 103, a control unit 104, and a communicating unit 105. The storage unit 101 is constituted by, for example, a rewriteable nonvolatile storage apparatus and stores, in advance, data necessary for providing the service (to be described later).

The operating unit 102 is constituted by, for example, a keyboard, a mouse, or the like and receives input of various kinds of information by an operator of the server 100. The display unit 103 is constituted by, for example, a liquid crystal display and displays various kinds of information. The control unit 104 is constituted by, for example, a CPU, a ROM, a RAM, and the like and performs necessary processing for providing a cloud service (to be described later). The communicating unit 105 is constituted by, for example, a communication apparatus for connecting the server 100 that is a modem or the like to the network NT.

The terminal apparatus 200 is constituted by, for example, a mobile terminal or a stationary computer. As the mobile terminal, for example, a smartphone, a tablet terminal, or a button type mobile phone is adopted. As the stationary computer, for example, a personal computer installed in the home of a user provided with the service is adopted.

In addition, the terminal apparatus 200 includes a control unit 201, a first communicating unit 202, an operating unit 203, a second communicating unit 204, a display unit 205, a storage unit 206, and a GPS sensor 207. The control unit 201 is constituted by, for example, a processor such as a CPU and is responsible for overall control of the terminal apparatus 200. The first communicating unit 202 is constituted by, for example, a communicating apparatus for connecting the terminal apparatus 200 to a mobile phone communication network and a communicating apparatus for connecting the terminal apparatus 200 to the Internet via an access point of a wireless LAN. The operating unit 203 is constituted by, for example, a keyboard or a mouse if the terminal apparatus 200 is a stationary computer. In addition, the operating unit 203 is constituted by a touch panel if the terminal apparatus 200 is a smartphone or a tablet terminal. Furthermore, the operating unit 203 is constituted by operating buttons such as a numerical keyboard if the terminal apparatus 200 is a button type mobile phone.

The second communicating unit 204 is constituted by a communicating apparatus that performs near field wireless communication such as NFC and communicates with the auxiliary apparatus 300. The display unit 205 is constituted by, for example, a liquid crystal panel and displays various kinds of information. In the present embodiment, the display unit 205 particularly displays information to be reported to the user by the server 100. The storage unit 206 is constituted by, for example, a rewriteable nonvolatile storage apparatus and stores application software and basic software. The GPS sensor 207 communicates with a GPS satellite to sense position information relating to the terminal apparatus 200. In the present embodiment, position information relating to the terminal apparatus 200 sensed by the GPS sensor 207 is handled as position information relating to the user carrying the terminal apparatus 200.

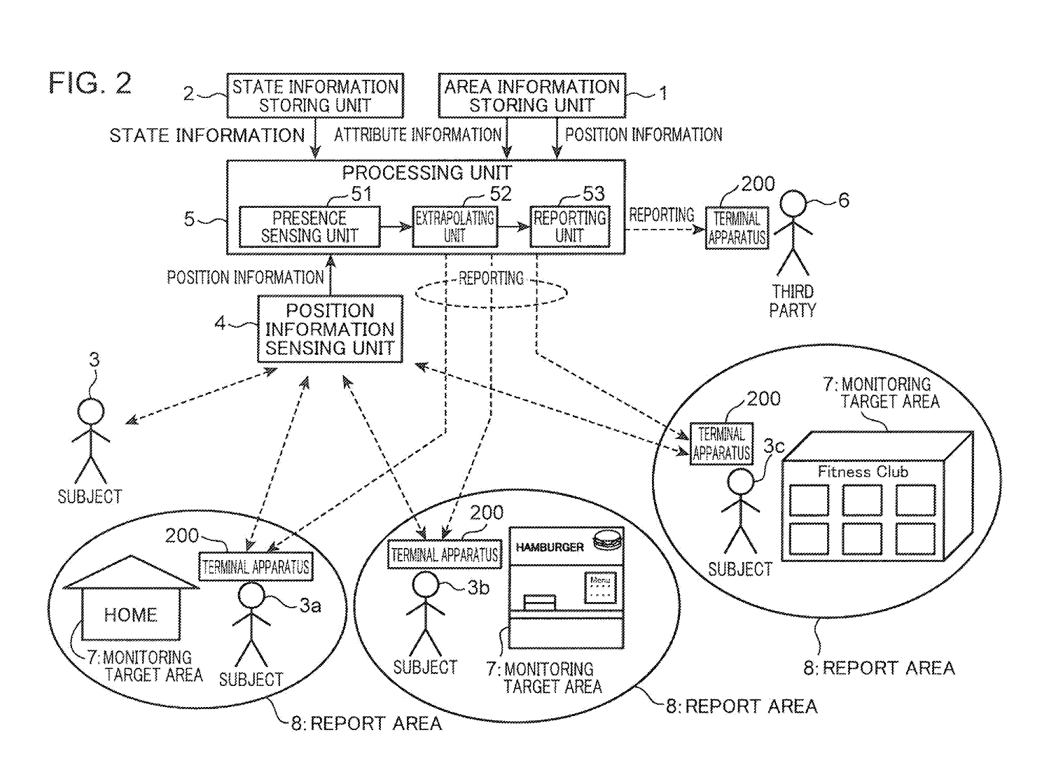

FIG. 2 is a block diagram showing an example of a functional configuration of the information reporting system according to the first embodiment. The information reporting system includes an area information storing unit 1, a state information storing unit 2, a processing unit 5, a position information sensing unit 4, and one or more terminal apparatuses 200.

The area information storing unit 1 stores area information in which position information and attribute information relating to a monitoring target area 7 are registered in advance. In this case, as the monitoring target area 7, the home of the subject 3 who is a monitoring target user as well as a location that conceivably influences the state of the subject 3 such as a hamburger shop and a fitness club are adopted. Therefore, as position information relating to the monitoring target area 7, for example, a latitude and a longitude representing actual position of the monitoring target area 7 in real space are adopted. Attribute information relating to the monitoring target area 7 includes, for example, a degree of influence that defines how much the monitoring target area 7 influences a state of a person. In this case, the degree of influence to be defined may represent an influence on people in general or an individual influence on the subject 3. The degree of influence includes, for example, a degree of positive influence that represents changing a state of a person to a positive state and a degree of negative influence that represents changing a state of a person to a negative state.

The state information storing unit 2 stores state information representing a state of the subject 3. In this case, the state information storing unit 2 stores state information from the present to a certain period of time in the past. Moreover, state information may be stored in the state information storing unit 2 by, for example, having the server 100 acquire, via the network NT, state information input by the subject 3 to the terminal apparatus 200. Alternatively, state information may be stored in the state information storing unit 2 by, for example, having the server 100 acquire, via the network NT, state information relating to the subject 3 transmitted by a state sensor that senses a state of the subject 3. For example, when a state regarding the weight of the subject 3 is adopted as state information, the server 100 may acquire, via the network NT, weight data input by the subject 3 using the terminal apparatus 200 or the server 100 may acquire, via the network N T, weight data transmitted by a weight scale. In addition, when a state of savings of the subject 3 is adopted as state information, the server 100 may access a bank server of a bank where the subject 3 has an account to acquire a state of savings of the subject 3. Moreover, the storage unit stored by the state information storing unit 2 is associated with a user ID and is managed per user.

The processing unit 5 is a functional unit responsible for processes performed by the information reporting system and includes a presence sensing unit 51, an extrapolating unit 52, and a reporting unit 53. The presence sensing unit 51 uses area information stored in the area information storing unit 1 and position information relating to the subject 3 as sensed by the position information sensing unit 4 to sense whether or not the subject 3 is present in a report area 8 including the monitoring target area 7. In this case, the report area 8 refers to a region in real space obtained by adding a small margin to the monitoring target area 7. When the monitoring target area 7 is a location that causes a negative variation in the state of the subject 3, if a message prompting the subject 3 to exit the monitoring target area 7 before the subject 3 enters the monitoring target area 7 can be reported, the state of the subject 3 can be prevented from deteriorating. Therefore, the presence sensing unit 51 senses whether or not the subject 3 is present in the report area 8 that is obtained by adding a small margin to the monitoring target area 7 instead of in the monitoring target area 7 itself.

In addition, when the monitoring target area 7 is a location that causes a positive variation in the state of the subject 3, if a message prompting the subject 3 to stay in the monitoring target area 7 can be reported when the subject 3 passes by the monitoring target area 7, the state of the subject 3 can be improved. Therefore, the presence sensing unit 51 senses whether or not the subject 3 is present in the report area 8 that is obtained by adding a small margin to the monitoring target area 7 instead of sensing whether or not the subject 3 is present in the monitoring target area 7 itself.

Specifically, in the attribute information relating to the monitoring target area 7, information representing scale is registered in advance in addition to information on the latitude and longitude of the monitoring target area 7. Therefore, the presence sensing unit 51 obtains a radius of a circle of the report area 8 including the monitoring target area 7 using the information representing scale and sets a circle centered on a position represented by the latitude and longitude of the monitoring target area 7. In addition, when the position information sensed by the position information sensing unit 4 represents a position within the set circle, the presence sensing unit 51 may determine that the subject 3 is present in the report area 8.

The extrapolating unit 52 uses the state information and the degree of influence of one subject 3 stored in the state information storing unit 2 to extrapolate the influence of the monitoring target area 7 in the sensed report area 8 on the state of the one subject 3. In this case, the extrapolated influence is not an influence on people in general but an individual influence on the subject 3 which takes the state of the subject into consideration. The extrapolating unit 52 determines whether the state of the subject 3 is in a positive state (good state) or a negative state (bad state) based on the state information relating to the subject 3, and by comparing a result of the determination with the degree of influence of the monitoring target area 7 defined in area information, the extrapolating unit 52 extrapolates whether the monitoring target area 7 has a negative influence or a positive influence on the state of the subject 3.

In this case, the extrapolating unit 52 may determine that the subject 3 is in a positive state when the state information relating to the subject 3 represents a tendency to approach a given target state and may determine that the subject 3 is in a negative state when the state information relating to the subject 3 represents a tendency to separate from the target state. For example, the target state is set in advance by the subject 3 himself/herself. If the subject 3 is on a diet, for example, a target weight or a target body fat ratio can be adopted.

For example, in a case where the degree of influence of the monitoring target area 7 is negative when the subject 3 is in a negative state, it is unfavorable for the subject 3 to stay in the monitoring target area 7. Therefore, when the subject 3 is in a negative state and, at the same time, the degree of influence of the monitoring target area 7 is negative, the extrapolating unit 52 extrapolates that the monitoring target area 7 is to have a negative influence on the subject 3.

On the other hand, even when the degree of influence of the monitoring target area 7 is negative, if the subject 3 is in a positive state, staying in the monitoring target area 7 does not cause an adverse effect greatly on the state of the subject 3. Instead, in this case, allowing the subject 3 to stay in the monitoring target area 7 and satisfy his/her desires contributes to relieving stress of the subject 3 and, from a long-term perspective, the state of the subject 3 can be improved. Therefore, when the subject 3 is in a positive state and, at the same time, the degree of influence of the monitoring target area 7 is negative, the extrapolating unit 52 extrapolates that the monitoring target area 7 is to have a positive influence on the subject 3.

In addition, in a case where the subject 3 is in a negative state and the degree of influence of the monitoring target area 7 is positive, it is favorable for the subject 3 to stay in the monitoring target area 7. Therefore, when the subject 3 is in a negative state and, at the same time, the degree of influence of the monitoring target area 7 is positive, the extrapolating unit 52 extrapolates that the monitoring target area 7 is to have a positive influence on the subject 3.

Furthermore, in a case where the subject 3 is in a positive state and the degree of influence of the monitoring target area 7 is positive, it is extremely favorable for the subject 3 to stay in the monitoring target area 7. Therefore, when the subject 3 is in a positive state and, at the same time, the degree of influence of the monitoring target area 7 is positive, the extrapolating unit 52 extrapolates that the monitoring target area 7 is to have a positive influence on the subject 3.

As described above, the extrapolating unit 52 extrapolates whether the monitoring target area 7 has a positive influence or a negative influence on the subject 3 by considering not only the degree of influence of the monitoring target area 7 but also the state of the subject 3. Therefore, an extrapolation with respect to whether or not the state of the subject 3 can be brought close to a target state can be performed not only in a short-term perspective but also in a long-term perspective. As a result, the target of the subject 3 can be surely accomplished.

The reporting unit 53 reports information whose content is in accordance with a result of the extrapolation by the extrapolating unit 52 to the subject 3. In this case, for example, when the extrapolating unit 52 extrapolates that the monitoring target area 7 has a positive influence on the subject 3, the reporting unit 53 may determine a positive report content, and when the extrapolating unit 52 extrapolates that the monitoring target area 7 has a negative influence on the subject 3, the reporting unit 53 may determine a negative report content. In addition, while the reporting unit 53 is configured so as to report information to the subject 3, the reporting unit 53 is not limited to this configuration and may report information to a third party 6 other than the subject 3. As the third party 6, for example, a person registered in advance is adopted. Furthermore, the reporting unit 53 may determine a report content using a report content table to which positive report contents and negative report contents are registered in advance.

Moreover, the server 100 may retain a user table to which user information relating to the subject 3 and the third party 6 is registered in advance, and by referring to the table, the server 100 may acquire a communication address of the terminal apparatus 200 of the subject 3 or the third party 6 who is a report target and transmit information to terminal apparatus 200. In this case, as the information, for example, a message described in a language such as HTML and XML is adopted.

The terminal apparatus 200 having received the information reports the information to the subject 3 or the third party 6 by displaying a message included in the information on the display unit 205 or the like. In this case, while a message is adopted as the information and perceptual reporting is performed to the subject 3 or the third party 6, this is simply an example and tactile or auditory reporting may be performed instead. Details will be provided in the embodiments described later.

The position information sensing unit 4 senses position information relating to the subject 3. Moreover, the position information sensing unit 4 is mounted to the terminal apparatus 200 carried by the subject 3. In this case, the position information sensing unit 4 may sense position information relating to the subject 3 by receiving a GPS signal. Alternatively, when the terminal apparatus 200 is connected to the network NT via an access point of a wireless LAN provided around the terminal apparatus 200 or via a base station of a mobile phone communication network, the position information sensing unit 4 may inquire the access point or the base station about access point information regarding the access point or base station information regarding the base station and sense the position information relating to the subject 3 using the acquired access point information or base station information. In this case, if the access point information includes position information relating to the subject the access point, the position information sensing unit 4 may adopt the position information as the position information relating to the subject 3. In a similar manner, if the base station information includes position information relating to the base station, the position information sensing unit 4 may adopt the position information as the position information relating to the subject 3.

Moreover, when the position information relating to the subject 3 is acquired using a GPS signal, the position information sensing unit 4 may be constituted by the GPS sensor 207. In addition, when the position information relating to the subject 3 is acquired based on access point information or base station information, the position information sensing unit 4 may be constituted by, for example, the first communicating unit 202. Moreover, the position information sensing unit 4 may acquire position information relating to the subject 3 by appropriately using both a method of sensing the position information relating to the subject 3 by acquiring a GPS signal and a method of sensing the position information relating to the subject 3 based on position information relating to an access point and a base station.

In FIG. 2, a subject 3a represents a state where the subject 3 stays in a report area 8 including the home of the subject 3, a subject 3b represents a state where the subject 3 stays in a report area 8 including a hamburger shop, and a subject 3c represents a state where the subject 3 stays in a report area 8 including a fitness club.

For example, let us assume that the subject 3 is on a diet and has entered the report area 8 of the hamburger shop while carrying the terminal apparatus 200 that is a mobile terminal or the like. In this case, for example, if the state of the subject 3b is negative, a negative message prompting the subject 3b to exit the hamburger shop is reported to the subject 3b. Accordingly, the subject 3b can be prevented from consuming high caloric food such as a hamburger and the state of the subject 3b can be prevented from deteriorating.

In addition, let us assume that the subject 3 who is on a diet enters the report area 8 of a fitness club. In this case, for example, a message with a positive content that prompts the subject 3c to stay at the fitness club is reported regardless of the state of the subject 3c. Accordingly, the subject 3c can exercise at the fitness club and burn off calories to improve his/her state.

Moreover, in FIG. 2, the area information storing unit 1, the state information storing unit 2, and the processing unit 5 may be mounted to, for example, the server 100, and the position information sensing unit 4 may be mounted to, for example, the terminal apparatus 200. However, this is simply an example and the components may be appropriated suitably between the server 100 and the terminal apparatus 200. For example, an aspect may be adopted in which the area information storing unit 1 and the state information storing unit 2 is mounted to the server 100 and the processing unit 5 and the position information sensing unit 4 are mounted to the terminal apparatus 200. Furthermore, the presence sensing unit 51, the extrapolating unit 52, and the reporting unit 53 that constitute the processing unit 5 may be distributed as appropriate between the server 100 and the terminal apparatus 200. For example, an aspect may be adopted in which the presence sensing unit 51 is mounted to the terminal apparatus 200 and the extrapolating unit 52 and the reporting unit 53 are mounted to the server 100.

In addition, in FIG. 2, the area information storing unit 1 and the state information storing unit 2 are constituted by, for example, the storage unit 101 of the server 100. Furthermore, the processing unit 5 is constituted by, for example, software, and the processing unit 5 is realized as a processor such as a CPU executes the software.

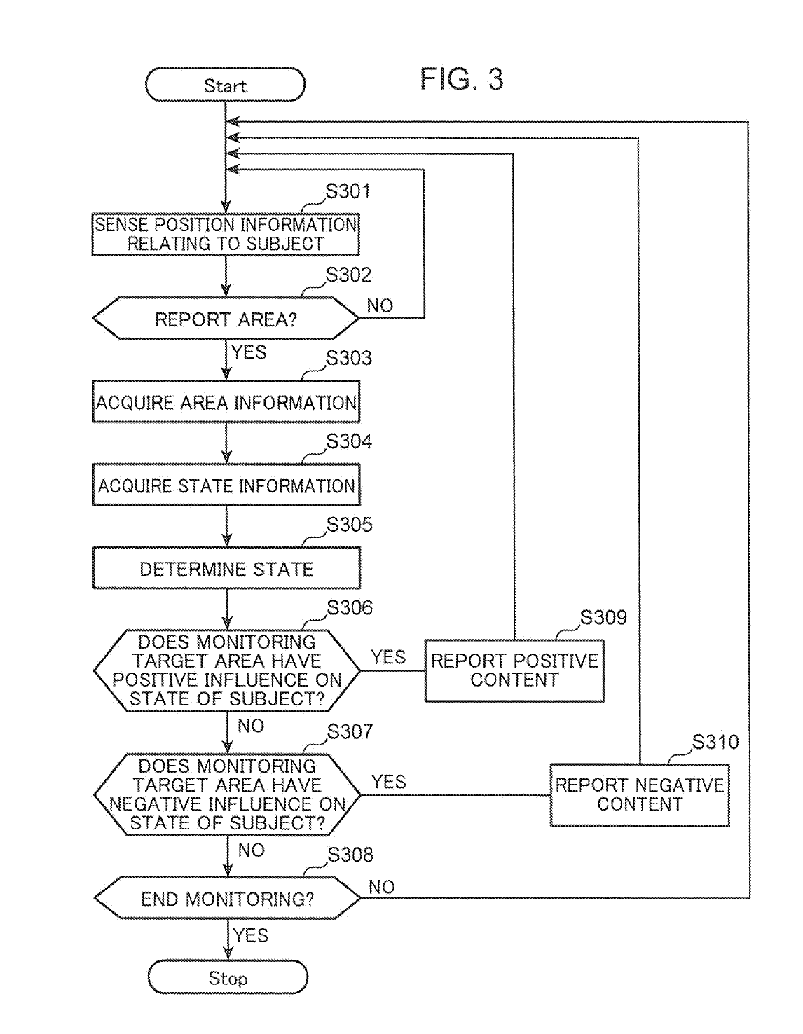

FIG. 3 is a flow chart showing an example of a process of the information reporting system according to the first embodiment. Hereinafter, an example of a process with respect to one subject 3 among users registered as users to the server 100 will be described. First, the position information sensing unit 4 senses position information relating to the subject 3 (S301). Next, the presence sensing unit 51 determines whether or not the subject 3 is present in any of the report areas 8 including the monitoring target area 7 registered in area information (S302).

When the subject 3 is present in any of the report areas 8 (yes in S302), the extrapolating unit 52 acquires area information relating to the monitoring target area 7 in the report area 8 from the area information storing unit 1 (S303). On the other hand, when the subject 3 is not present in any report area 8 (no in S302), the process is returned to S301.

In S304, the extrapolating unit 52 acquires state information relating to the subject 3 from the present to a certain period of time in the past from the state information storing unit 2. Next, the extrapolating unit 52 determines whether the state of the subject 3 is in a positive state or a negative state (S305).

Subsequently, the extrapolating unit 52 extrapolates whether or not the monitoring target area 7 is to have a positive influence on the subject 3 using a result of the determination of the state of the subject 3 and a degree of influence of the monitoring target area 7 (S306). When it is extrapolated that the monitoring target area 7 is to have a positive influence on the subject 3 (yes in S306), the reporting unit 53 generates a message with a positive content, reports the message to at least one of the subject 3 and the third party 6 (S309), and returns the process to S301.

On the other hand, when it is extrapolated that the monitoring target area 7 is to have a negative influence on the subject 3 (no in S306, yes in S307), the reporting unit 53 generates a message with a negative content, reports the message to at least one of the subject 3 and the third party 6 (S310), and returns the process to S301.

In S307, when it is determined that the monitoring target area 7 is not to have a negative influence on the state of the subject 3 (no in S307), the process is advanced to S308. In S308, when the subject 3 satisfies an end condition of monitoring (yes in S308), the processing unit 5 ends the monitoring of the subject 3. On the other hand, when the subject 3 does not satisfy the end condition of monitoring (no in S308), the process is returned to S301. In this case, as the end condition of monitoring, for example, a case where the subject 3 has input an instruction to abort monitoring, a case where the state of the subject 3 has reached a target state, or a case where a monitoring period has expired can be adopted.

As described above, according to the present embodiment, when the subject 3 is present in the monitoring target area 7, an influence of the monitoring target area 7 on the subject 3 is extrapolated. When the monitoring target area 7 has a positive influence on the state of the subject 3, information with a positive content is generated and reported to the subject 3. Therefore, the subject 3 can be prompted to stay in the monitoring target area 7 to improve the state of the subject. On the other hand, when the monitoring target area 7 has a negative influence on the state of the subject 3, information with a negative content is generated and reported to the subject 3. Therefore, the subject 3 can be prompted to exit the monitoring target area 7 to prevent deterioration of the state of the subject 3.

### Second Embodiment

An information reporting system according to the second embodiment provides a dieting service to the subject 3. Moreover, the second to thirteenth embodiments described below will also be described using an example where a dieting service is provided to the subject 3. In the present embodiment, similar components to the first embodiment will be denoted by similar reference numerals and a description thereof will be omitted.

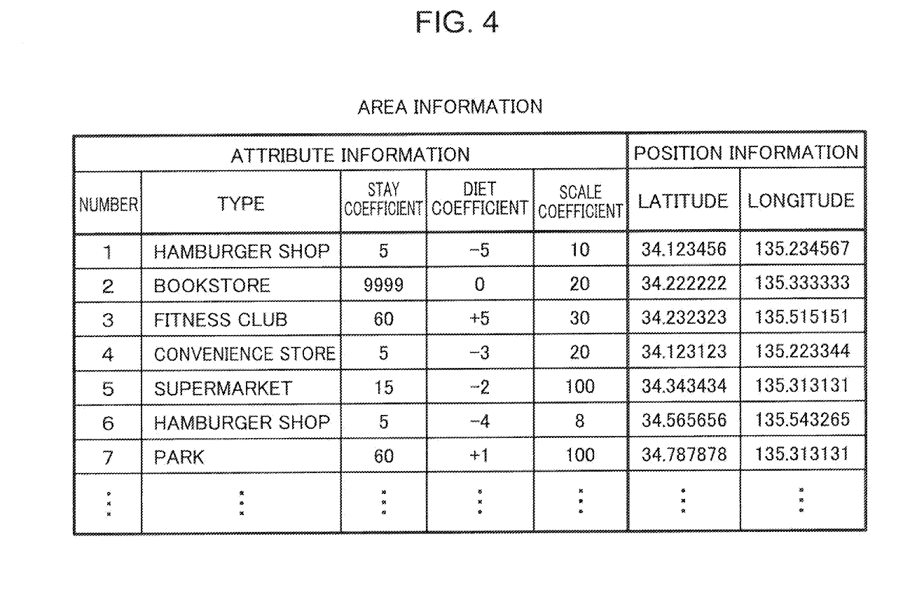

FIG. 4 is a diagram showing an example of data configuration of area information stored by the area information storing unit 1 according to the second embodiment.

Area information includes attribute information and position information. Attribute information is information representing attributes such as a type and a degree of influence of the monitoring target area 7. In the example shown in FIG. 4, attribute information includes a number, a type, a stay coefficient, a diet coefficient, and a scale coefficient. The number is an identification number of the monitoring target area 7. The type is information representing a type of the monitoring target area 7. In the example shown in FIG. 4, information representing a type of store such as a hamburger shop, a book store, and a fitness club and information representing a type of a location such as a park are registered as the type.

The stay coefficient is a coefficient for calculating a period of time which enables a determination to be made that staying at the monitoring target area 7 will influence the diet. The diet coefficient is an example of a degree of influence and is a coefficient indicating how much the monitoring target area 7 is to influence a state of the diet of the subject 3. In the example shown in FIG. 4, a diet coefficient is defined by integer values equal to or greater than −5 and equal to or smaller than +5, and assumes a negative value when there is a negative influence on the diet state and a positive value when there is a positive influence on the diet state. In addition, for the diet coefficient, the larger the influence on the diet state, the greater an absolute value is defined. However, these numerical values merely represent an example and a numerical value other than −5 may be adopted as a lower limit value and a numerical value other than +5 may be adopted as an upper limit value.

The scale coefficient is an indicator representing an area scale of the monitoring target area 7. In this case, a relative value of the monitoring target area 7 with respect to a given unit area is adopted as the scale coefficient.

The position information represents a position in real space of the monitoring target area 7. In the example shown in FIG. 4, a latitude and longitude are adopted as the position information.

In FIG. 4, the monitoring target area 7 that is numbered “I” is a hamburger shop. For the subject 3 who is on a diet, the hamburger shop has a risk that calorie intake may increase. Therefore, “−5” is registered as the diet coefficient of the hamburger shop. In addition, with respect to the hamburger shop, “5” is registered as a stay coefficient, “10” is registered as a scale coefficient, and “34.123456 degrees north, 135.234567 degrees east” is registered as position information.

From these pieces of information, the report area 8 of the monitoring target area 7 that is assigned number “1” is determined as a circular area centered at 34.123456 degrees north, 135.234567 degrees east and having the following area radius.

Area radius R=10(scale coefficient)·S(scale constant):

where the scale constant S is a constant for converting a scale of an area scale represented by the scale coefficient into an area scale in real space.

When the scale constant S is 1, the report area 8 to which is assigned number “1” is a circular area centered at 34.123456 degrees north, 135.234567 degrees east and has a radius of 10 m.

In addition, “5” is registered as a stay constant of the hamburger shop. Therefore, when the subject 3 stays at the report area 8 of the hamburger shop, which is assigned number “1”, for 5 minutes, the extrapolating unit 52 extrapolates that there is a strong possibility that the subject 3 is purchasing a hamburger and determines that the diet state of the subject 3 is to be influenced.

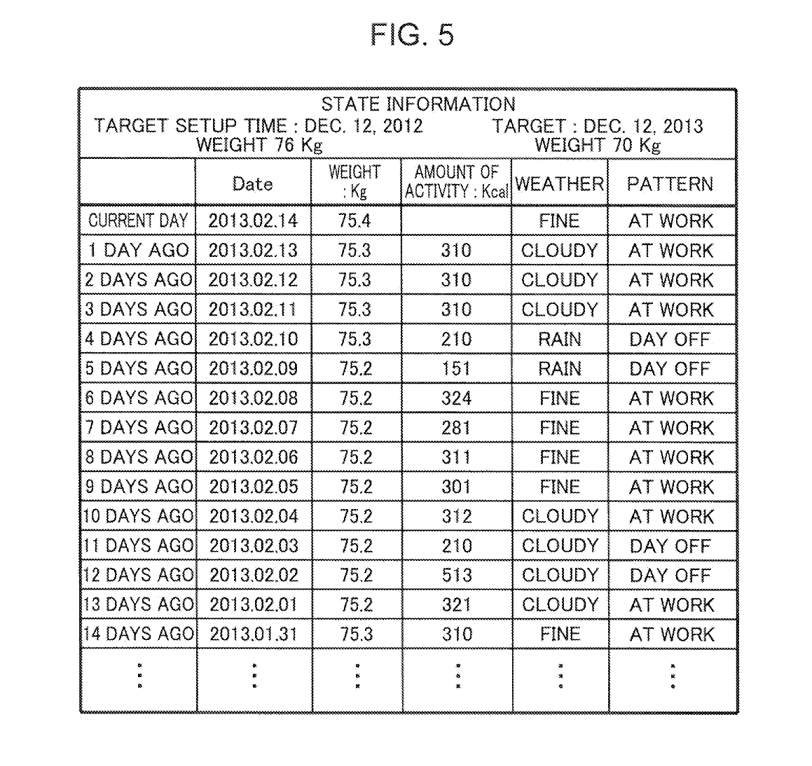

FIG. 5 is a diagram showing an example of data configuration of area information stored by the state information storing unit 2 according to a fifth embodiment. Moreover, the state information shown in FIG. 5 is state information relating to one subject 3 who is on a diet.

In the example shown in FIG. 5, the weight of the subject 3 was 76 kg as of Dec. 12, 2012 upon target setup. In addition, the subject 3 sets a target of the diet to 70 kg on Dec. 12, 2013 which is one year after target setup.

State information includes the items of date, weight, amount of activity, weather, and pattern. A measurement date is registered to the date item. In the example shown in FIG. 4, the higher the record, the newer the measurement date and state information is registered in chronological order. In addition, state information on a latest measurement date is registered in the record in a first row.

The weight of the subject 3 on a measurement date is registered in the weight item. The amount of activity of the subject 3 on a measurement date is registered in the amount of activity item. As the amount of activity, for example, calories consumed by the subject 3 on a measurement date is adopted. Weather on a measurement date is registered in the weather item. A pattern of activity of the subject on a corresponding measurement date is registered in the pattern item. In addition, in the example shown in FIG. 4, in the first line, information indicating the number of days by which each measurement date precedes a current day that is a latest measurement date.

In the example shown in FIG. 5, for Feb. 14, 2013 that is a current day, 75.4 kg is registered as the weight and “at work” is registered as the pattern of activity. In addition, for Feb. 13, 2013 that is the previous day, 75.3 kg is registered as the weight and 310 Kcal is registered as the amount of activity.

Since a target setting period is one year, weight loss targets for one day, one week, and one month are, respectively, approximately 16 g (=6000 g/365 days), approximately 115 g (=6000 g/52 days), and approximately 500 g (=6000 g/12 months). Since the number of days from target setup to the current day is 65 days, the target weight as of Feb. 14, 2013 is approximately 74.9 kg which represents a weight loss of 1.04 kg (=16 g/day·65 days), whereas the current weight represents a weight loss of approximately 0.6 kg (=76−75.4). Therefore, an overall achievement rate is approximately 57% (=0.6 kg/1.04 kg), which clearly shows that a significant setback has occurred.

Furthermore, daily increase/decrease in weight indicate an increasing trend, which shows that, even from a short-term perspective, process of the diet is not very good. In consideration thereof, in the present embodiment, a degree of progress of the diet is observed from both a long-term perspective and a short-term perspective to determine whether a diet state is good or bad.

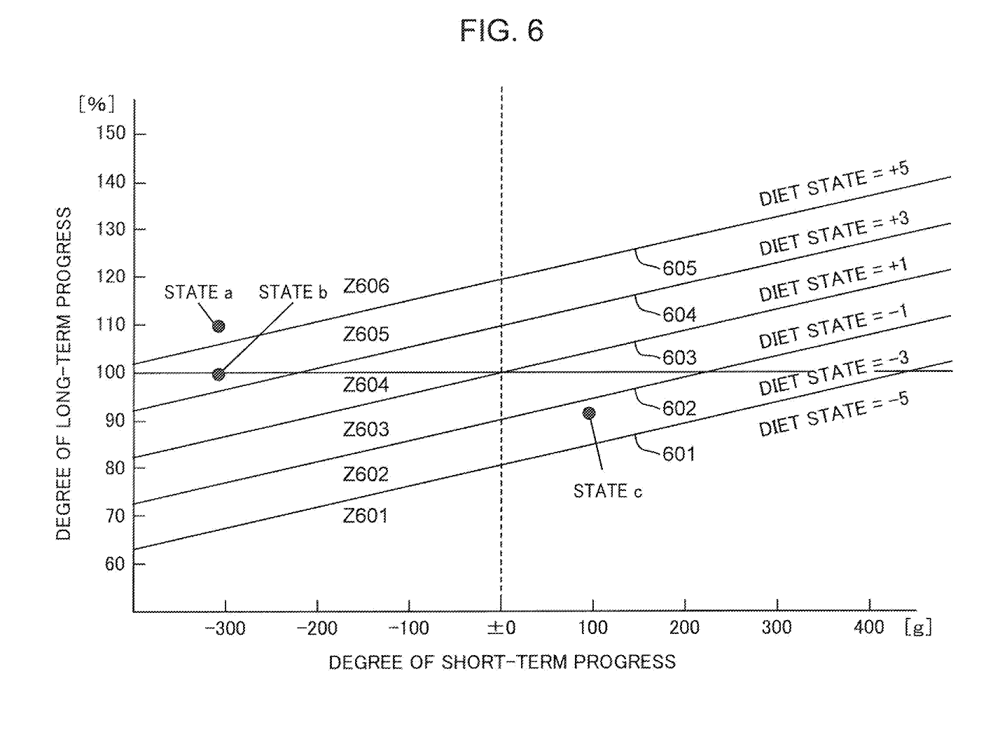

FIG. 6 is a graph used when determining whether a diet state is good or bad according to the second embodiment. In FIG. 6, an ordinate indicates a degree of long-term progress of a diet state and an abscissa indicates a degree of short-term progress of a diet state.

In this case, a degree of long-term progress represents a ratio of an actual amount of weight loss during a period from target setup to the current day against a target amount of weight loss to be achieved during the period from target setup to the current day. Therefore, the degree of long-term progress indicates a good state as a value thereof increases. The overall achievement rate of 57% on Feb. 14, 2013 shown in the example described earlier corresponds to a long-term achievement rate.

On the other hand, the degree of short-term progress represents an amount of weight loss to be achieved during a short-term period (three days in the example shown in FIG. 6) among an amount of weight loss during the same period. Therefore, the degree of short-term progress indicates a good state as a value thereof decreases. For example, in the example shown in FIG. 5, the amount of weight loss during the three days from the current day to two days ago is 75.4−75.3=+0.1 kg. Meanwhile, the amount of weight loss to be achieved during the three days is 3 days·16 g/days=48 g. Therefore, the degree of short-term progress is 100 g−48 g=+52 g.

The graph shown in FIG. 6 is divided into six zones Z601 to Z606 by five straight lines 601 to 605. Diet states of “−5”, “−3”, “−1”, “+1”, “+3”, and “+5” are respectively assigned to the zones Z601 to Z606. In this case, a diet state represents a good state when a value thereof increases and represents a bad state when a value thereof decreases. The straight lines 601 to 605 have intersecting points with the ordinate whose values are greater in this order and respectively have a same right-upward incline. Therefore, as the degree of long-term progress improves, the value of the diet state increases, and as the degree of short-term progress deteriorates, the value of the diet state decreases. In addition, even when the degree of long-term progress is the same, the value of the diet state increases as the degree of short-term progress improves. Furthermore, even when the degree of short-term progress is the same, the value of the diet state increases as the degree of long-term progress improves.

State a shows that the degree of long-term progress is 110% and the diet is progressing in a favorable manner. In addition, state a shows that the degree of short-term progress is −300 g and that the diet is progressing extremely favorably. Therefore, for state a, “+5” which is the maximum value of a diet state is set as the diet state of the subject 3.

In state b, while the degree of short-term progress of −300 g is favorable in a similar manner to state a, the degree of long-term progress is 100% and is as planned. Therefore, for state b, “+3” which is a lower value than that of state a is set as the diet state.

In state c, since the degree of long-term progress is at a low level of 90% and the degree of short-term progress is also +100 g, state c represents a bad state with respect to both the long term and the short term. Therefore, in the case of state c, the diet state is set to “−3” which represents a bad state.

As described above, in the second embodiment, the extrapolating unit 52 calculates a degree of long-term progress and a degree of short-term progress of the diet based on state information stored in the state information storing unit 2. In addition, the extrapolating unit 52 plots the degree of long-term progress and the degree of short-term progress as states of the subject 3 on the graph shown in FIG. 6 and sets a value assigned to a zone to which a plotted state belongs as a diet state (an example of an overall state).

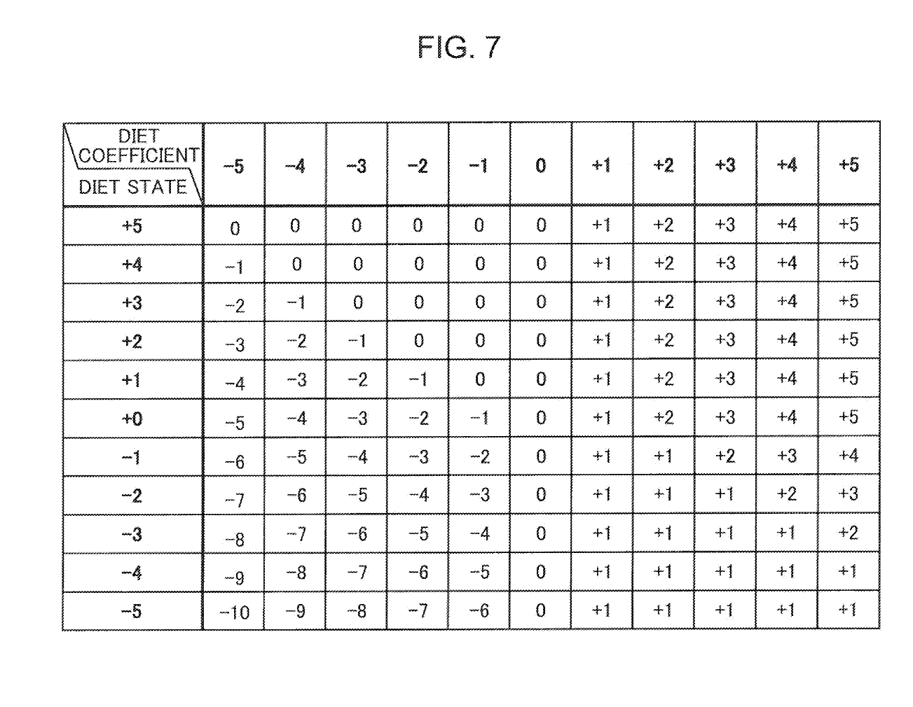

FIG. 7 is a diagram showing an example of a data configuration of a value determining table used when determining a reporting value according to the second embodiment. The value determining table is stored in, for example, the state information storing unit 2 shown in FIG. 2. A reporting value corresponding to a combination of a diet coefficient and a diet state is registered in advance in the value determining table. In this case, the extrapolating unit 52 determines a reporting value corresponding to a diet state and a degree of influence of the monitoring target area 7 from the value determining table and extrapolates the determined reporting value as an influence of the monitoring target area 7 on the subject 3.

A reporting value with a positive value represents a positive reporting value, a reporting value with a negative value represents a negative reporting value, and an absolute value represents a magnitude of the reporting value. In the example shown in FIG. 7, reporting values are registered so that the reporting value increases as the diet coefficient increases and the reporting value decreases as the diet coefficient decreases.

Let us assume that the subject 3 in state a whose diet state is “+5” has stayed in the report area 8 of the hamburger shop numbered “1”. The diet coefficient of the hamburger shop is “−5” in the example shown in FIG. 4. In this case, the extrapolating unit 52 determines the reporting value to be “0”.

In addition, let us assume that the subject 3 in state b whose diet state is “+3” has stayed in the report area 8 of the hamburger shop. In this case, the extrapolating unit 52 determines the reporting value to be “−2”.

Furthermore, let us assume that the subject 3 in state c whose diet state is “−3” has stayed in the report area 8 of the hamburger shop. In this case, the extrapolating unit 52 determines the reporting value to be “−8”.

Therefore, a stay at the hamburger shop numbered “1” by the subject 3 in the state b becomes a target of reporting with a negative content. In addition, a stay at the hamburger shop numbered “1” by the subject 3 in the state c becomes a target of reporting with an even more negative content. On the other hand, in the case of the state a, since the diet state is good, the reporting value is determined to be a low value even at a hamburger shop that is inappropriate to a diet. Furthermore, when the subject 3 in the state a, the state b, or the state c stays at number “3” with a diet coefficient of “+5”, the reporting value is respectively “+5”, “+5”, or “+2”.

The reporting unit 53 reports information determined in advance to the subject 3 and the third party 6 in accordance with the reporting value determined by the extrapolating unit 52. In this case, for example, when a period of stay by the subject 3 at the report area 8 is equal to or shorter than a period of time indicated by the stay coefficient in a case where the determined reporting value has a negative value, the reporting unit 53 is to report, to the subject 3, a message with a content praising the activity of the subject 3. For example, the stay coefficient of the hamburger shop numbered “1” is “5”. Therefore, when the subject 3 whose reporting value is determined to be “−5” exits the report area 8 of the hamburger shop within 5 minutes after entry, for example, the reporting unit 53 reports a message of praise such as “You resisted temptation well”.

According to the present embodiment, when the subject 3 who is on a diet enters the report area 8 having a negative influence on the diet state but exits the report area 8 within a certain amount of time, determination is made that it is highly probable that the subject 3 did not engage in a negative activity and a message of praise is reported. As a result, the motivation of the subject 3 for dieting can be further increased. Moreover, while the report area 8 has a circular shape in the description given above, this is simply an example and other shapes such as a square and a triangle may be adopted instead. In addition, a region obtained by adding a small margin to a shape itself of a region of the monitoring target area 7 on the ground surface may be adopted as the report area 8.

### Third Embodiment

A third embodiment differs from the second embodiment in that different report conditions are adopted. Moreover, in the present embodiment, similar components to the first and second embodiments will be denoted by similar reference numerals and a description thereof will be omitted.

In the present embodiment, processes up to determining a reporting value are the same as in the second embodiment. When a period of stay by the subject 3 at the report area 8 exceeds a period of time indicated by the stay coefficient in a case where a reporting value determined by the extrapolating unit 52 has a negative value, the reporting unit 53 is to report, for example, a message of warning to the subject 3. For example, the stay coefficient of the hamburger shop numbered “1” is “5”. Therefore, when the subject 3 whose reporting value is determined to be “−5” stays in the report area 8 of the hamburger shop more than five minutes, the reporting unit 53 reports a warning such as “You are on a diet. Exit the hamburger shop immediately!” to the subject 3.

According to the present embodiment, when the subject 3 who is on a diet enters the report area 8 having a negative influence on the diet state and stays in the report area 8 more than a certain amount of time, it is determined that the subject 3 is highly likely to engage in a negative activity and a message of warning is reported. As a result, even if the subject 3 forgets that he/she is on a diet or gives in to temptation and enters a store offering high caloric food, the subject 3 is prevented from consuming high caloric food and deterioration of the diet state of the subject 3 can be prevented.

### Fourth Embodiment

A fourth embodiment varies warning methods when a period of stay in the report area 8 is extended in the third embodiment. Moreover, in the present embodiment, similar components to the first to third embodiments will be denoted by similar reference numerals and a description thereof will be omitted.

In the present embodiment, processes up to determining a reporting value are the same as in the second embodiment. When a period of stay by the subject 3 at the report area 8 exceeds a period of time indicated by the stay coefficient in a case where a reporting value determined by the extrapolating unit 52 has a negative value, the reporting unit 53 is to report, for example, a message of warning to the subject 3 in a similar manner to the third embodiment.

In addition, in the present embodiment, when the subject 3 extends his/her stay in the report area 8 despite being reported of a warning message, the reporting unit 53 reports a message whose content differs from the warning message reported earlier to the subject 3 and varies warning methods. In this case, an example of a variation in warning methods is a method of reporting a message whose content has a higher warning severity than the message sent earlier to the subject 3. Further examples of a variation in warning methods include a method in which a message with a same content as the message sent earlier or message whose content has a higher warning severity is reported to the subject 3 and, at the same time, a voice reading out the message is output from the terminal apparatus 200 of the subject 3 and a method of outputting a beep from the terminal apparatus 200 of the subject 3.

In this case, the reporting unit 53 may repetitively issue warnings as long as the subject 3 stays in the report area 8. In doing so, the reporting unit 53 may report messages with higher warning severity to the subject 3 as the number of warnings increases or may gradually increase the volume of a voice or a beep output by the terminal apparatus 200. Moreover, for example, the reporting unit 53 may report a warning message each time a period of time indicated by the stay coefficient of the monitoring target area 7 arrives.

According to the present embodiment, when the subject 3 who is on a diet enters the report area 8 that has a negative influence on the diet state and continues to stay there despite being reported of a warning message, since warning methods are varied, the subject 3 can be more reliably prevented from engaging in a negative activity. In addition, in a case where the diet state is good and the reporting value has a positive value, since a warning is not issued even when the subject 3 enters a location with a low diet coefficient, a sense of psychological superiority can be relayed to the subject 3.

### Fifth Embodiment

A fifth embodiment differs from the second to fourth embodiments in that different report conditions are adopted. Moreover, in the present embodiment, similar components to the first to fourth embodiments will be denoted by similar reference numerals and a description thereof will be omitted.

In the present embodiment, processes up to determining a reporting value are the same as in the second embodiment. When a period of stay by the subject 3 at the report area 8 exceeds a period of time indicated by the stay coefficient in a case where a reporting value determined by the extrapolating unit 52 has a positive value, the reporting unit 53 is to report, for example, a message of praise to the subject 3. For example, the stay coefficient of the fitness club numbered “3” is “60”. Therefore, when the subject 3 whose reporting value is determined to be “+5” stays in the report area 8 of the fitness club more than 60 minutes, the reporting unit 53 reports a message of praise such as “That was a tough workout. You did great.” to the subject 3.

According to the present embodiment, when the subject 3 whose diet state is favorable enters the report area 8 having a positive influence on the diet state and stays in the report area 8 more than a certain amount of time, determination is made that it is highly probably that the subject 3 has engaged in a positive activity and a message of praise is reported. As a result, the motivation of the subject 3 for dieting can be further increased.

### Sixth Embodiment

A sixth embodiment varies reporting methods when a period of stay in the report area 8 is extended in the fifth embodiment. Moreover, in the present embodiment, similar components to the first to fifth embodiments will be denoted by similar reference numerals and a description thereof will be omitted.

In the present embodiment, processes up to determining a reporting value are the same as in the second embodiment. When a period of stay by the subject 3 at the report area 8 exceeds a period of time indicated by the stay coefficient in a case where a reporting value determined by the extrapolating unit 52 has a positive value, the reporting unit 53 is to report, for example, a message of praise to the subject 3 in a similar manner to the fifth embodiment.

In addition, in the present embodiment, when the subject 3 extends his/her stay in the report area 8 after being reported of a message of praise, the reporting unit 53 reports a message whose content differs from the message of praise reported earlier to the subject 3 and varies methods of praise. In this case, an example of a variation in methods of praise is a method of reporting a message whose content has a higher degree of praise than the message sent earlier to the subject 3. Alternatively, an example of a variation in methods of praise is a method of granting a privilege to the subject 3. Examples of granting a privilege include a method of awarding image data of a celebrity (an athlete or an entertainer) who the subject 3 likes, a method awarding a stamp that imparts a sense of fulfillment the subject 3 feels when the subject 3 collected stamps, and a method of awarding points of a credit card of the subject 3 through a tie-up with a credit card company.

In this case, the reporting unit 53 may repetitively report messages of praise as long as the subject 3 stays in the report area 8. In doing so, the reporting unit 53 may report a message with a stronger degree of praise to the subject 3 as the number of praises increases. Moreover, for example, the reporting unit 53 may report a message of praise each time a period of time indicated by the stay coefficient of the monitoring target area 7 arrives.

According to the present embodiment, methods of praise are varied when the subject 3 whose diet state is favorable enters the report area 8 having a positive influence on the diet state and continues to stay in the report area 8, the subject 3 is further promoted to engage in a positive activity.

### Seventh Embodiment

In a seventh embodiment, a message that evokes a sense of discomfort in the subject 3 is reported when performing reporting of a negative content to the subject 3. Moreover, in the present embodiment, similar components to the first to sixth embodiments will be denoted by similar reference numerals and a description thereof will be omitted.

In the present embodiment, processes up to determining a reporting value are the same as in the second embodiment. When performing reporting of a negative content to the subject 3 in a case where a reporting value as determined by the extrapolating unit 52 has a negative value, the reporting unit 53 reports a message that evokes a sense of discomfort in the subject 3. Examples of a message that evokes a sense of discomfort include a message reading “Do you want to get fat?”, a message to which is attached a simulated image of the subject 3 after gaining weight, and a message to which is attached an image which the subject 3 abhors.

According to the present embodiment, since a message that evokes a sense of discomfort in the subject 3 is reported when performing reporting of a negative content to the subject 3, an effect of suppressing negative activity by the subject 3 can be enhanced.

### Eighth Embodiment

In an eighth embodiment, a message that is inappropriate for the monitoring target area 7 in which the subject 3 is to stay is reported when performing reporting of a negative content to the subject 3. Moreover, in the present embodiment, similar components to the first to seventh embodiments will be denoted by similar reference numerals and a description thereof will be omitted.

In the present embodiment, processes up to determining a reporting value are the same as in the second embodiment. When performing reporting of negative content to the subject 3 in a case where a reporting value as determined by the extrapolating unit 52 has a negative value, the reporting unit 53 reports a message that is inappropriate for the monitoring target area 7 in which the subject 3 is to stay.

In this case, as the inappropriate message, for example, a message which displays calories in a hamburger or french fries and, at the same time, indicates a type of exercise and a duration of exercise necessary to consume the calories can be adopted. Alternatively, an example of an inappropriate message is a message reading “Food available at a hamburger shop is high in calories and will surely make you fat”. Alternatively, an example of an inappropriate message is a method of having the terminal apparatus 200 of the subject 3 output a beep or an alarm to make it difficult for the subject 3 to stay at the hamburger shop.

According to the present embodiment, since a message that is inappropriate for the monitoring target area 7 at which the subject 3 is staying is reported when performing reporting of a negative content to the subject 3, an effect of suppressing negative activity by the subject 3 can be enhanced.

### Ninth Embodiment

A ninth embodiment adopts at least one of an auditory message using sound, a visual message using light, an olfactory message using odor, and a tactile message using heat or electrical stimulation as the message to be reported to the subject 3 by the reporting unit 53.

As a method of realizing reporting of an auditory message, for example, a method can be adopted in which a control command that causes a beep, a voice, or an alarm to be output from the terminal apparatus 200 of the subject 3 is transmitted by the reporting unit 53 to the terminal apparatus 200 of the subject 3.

As a method of realizing reporting of a visual message, for example, a method of increasing brightness of the display unit 205 of the terminal apparatus 200 can be adopted. Alternatively, if the terminal apparatus 200 is a mobile terminal equipped with a strobe, a method can be adopted in which a command for lighting the strobe is transmitted by the reporting unit 53 to the terminal apparatus 200.

As a method of realizing reporting of an olfactory message, for example, when the terminal apparatus 200 is a mobile terminal, a mobile phone strap with a built-in communication apparatus capable of communicating with an odor generator and the second communicating unit (refer to FIG. 1) is adopted as the auxiliary apparatus 300 (refer to FIG. 1) and is attached to the mobile terminal. In addition, the reporting unit 53 may transmit a command that causes an odor to be generated by the odor generator to the mobile terminal of the subject 3 and the command may be transmitted from the mobile terminal to the mobile phone strap using near field wireless communication.

As a method of realizing reporting of a tactile message, for example, the subject 3 is made to wear a wrist band type auxiliary apparatus 300 in which is built in a heat source or a vibrator as well as a communication apparatus capable of communicating with the second communicating unit (refer to FIG. 1). In addition, the reporting unit 53 may transmit a command for driving the heat source or the vibrator to the mobile terminal of the subject 3 and the command may be transmitted from the mobile terminal to the wrist band type auxiliary apparatus 300 using near field wireless communication. Alternatively, when a wrist band type mobile terminal is adopted as the terminal apparatus 200, the reporting unit 53 may directly transmit a command for driving the heat source or the vibrator to the terminal apparatus 200.

Furthermore, when the wrist band type auxiliary apparatus 300 is adopted, if the auxiliary apparatus 300 is configured so as to be capable of passing a current to an arm of the subject 3 and providing stimulation to the subject 3, the reporting unit 53 may transmit a command for passing a current to the arm of the subject 3 to the auxiliary apparatus 300 via the mobile terminal of the subject 3.

In addition, when the wrist band type auxiliary apparatus 300 is adopted, if the auxiliary apparatus 300 is configured so as to be capable of tightening around the arm of the subject 3 and applying pressure to the subject 3, the reporting unit 53 may transmit a command for tightening around the arm of the subject 3 to the auxiliary apparatus 300 via the mobile terminal of the subject 3.

Furthermore, when the wrist band type auxiliary apparatus 300 is adopted, if the auxiliary apparatus 300 is configured so as to be capable of splitting up into a plurality of parts, the reporting unit 53 may transmit a command for causing the auxiliary apparatus 300 to split up to the auxiliary apparatus 300 via the mobile terminal of the subject 3.

According to the present embodiment, since sound, light, odor, vibration, heat, or electrical stimulation is adopted as the message to be reported by the reporting unit 53 to the subject 3, a message delivery effect can be enhanced. Moreover, in the present embodiment, visual, auditory, olfactory, and tactile messages may be combined as appropriate to be reported to the subject 3, or may be further combined with the perceptual message using words as described above to be reported to the subject 3.

### Tenth Embodiment

In a tenth embodiment, the reporting unit 53 reports a message to a report destination that is at least one of the subject 3 who is a monitoring target and a separately registered third party 6. Moreover, in the present embodiment, similar components to the first to ninth embodiments will be denoted by similar reference numerals and a description thereof will be omitted.

In this case, as the third party 6, for example, a person registered in advance such as a family member (for example, a spouse, a child, and a parent) of the subject 3 or a health insurance doctor can be adopted. Specifically, the reporting unit 53 may refer to a user table in which user information relating to the subject 3 and the third party 6 associated with the subject 3 is registered in advance, determine a communication address of the corresponding third party 6, and transmit a message to the determined communication address.

Moreover, the reporting unit 53 may vary report contents and whether or not reporting is to be performed for each report destination according to the monitoring target area 7 in the report area 8 in which a stay of the subject 3 has been sensed. For example, a mode may be adopted in which, when the third party 6 is the wife of the subject 3 and a message such as “Exit the hamburger shop!” is reported to the subject 3, a message reading “Your husband is currently in a hamburger shop” is reported to the third party 6 who is the wife of the subject 3.

### Eleventh Embodiment

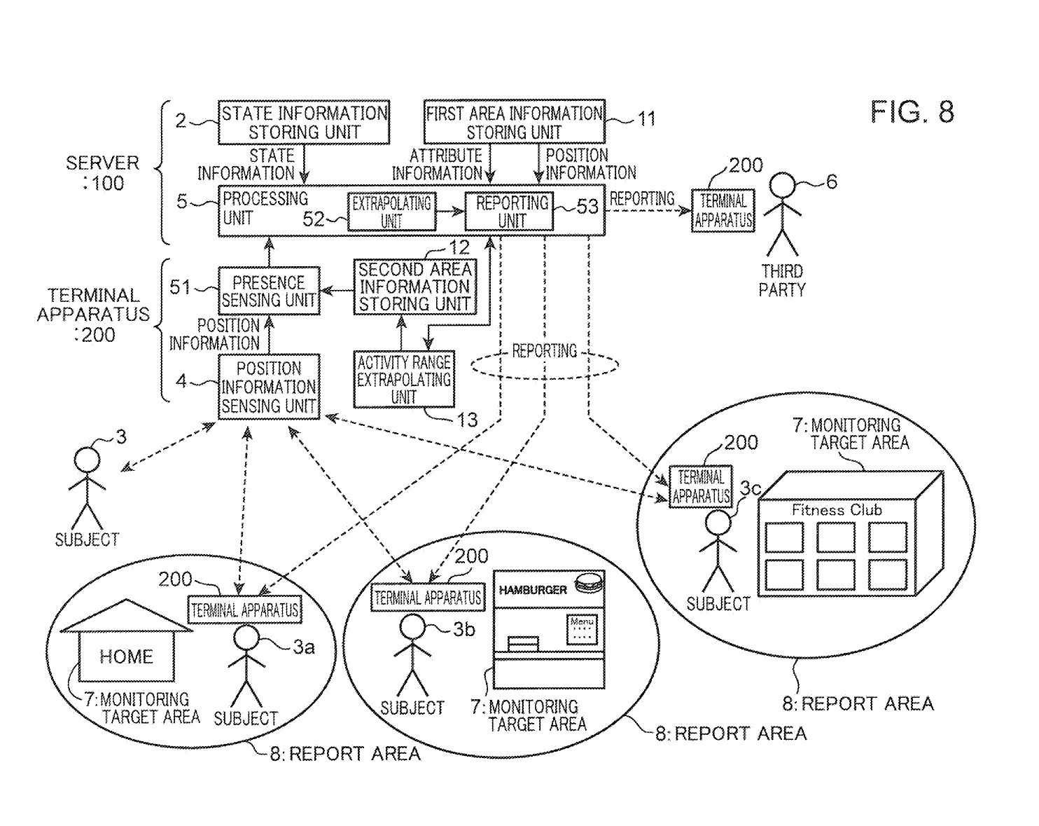

In an eleventh embodiment, the terminal apparatus 200 senses whether or not the subject 3 is present in the report area 8. FIG. 8 is a diagram showing an example of an overall configuration of an information reporting system according to the eleventh embodiment of the present invention. FIG. 8 differs from FIG. 2 in that the presence sensing unit 51, a second area information storing unit 12, and an activity range extrapolating unit 13 are provided in the terminal apparatus 200 carried by the subject 3. Accordingly, the area information storing unit 1 included in the server 100 is described as a first area information storing unit 11. Other components are the same as those of the first embodiment.

The first area information storing unit 11 is the same as the area information storing unit 1 shown in FIG. 2 and stores area information to which attribute information and position information are registered for all monitoring target areas 7 which the server 100 considers to be monitoring targets.

The second area information storing unit 12 stores area information to which attribute information and position information are registered for monitoring target areas 7 within an activity range of the subject 3.

The activity range extrapolating unit 13 stores position information relating to the subject 3 as sensed by the position information sensing unit 4 as history in a nonvolatile memory (not shown). In addition, the activity range extrapolating unit 13 extrapolates an activity range of the subject 3 from the stored position information. Examples of an extrapolation method include a method in which the sensed position information is plotted on map data divided into a plurality of blocks and votes are casted to respective blocks, blocks in which the number of votes is equal to or greater than a certain value are extracted, and a single region obtained by joining the extracted blocks is determined as the activity range of the subject 3.

In addition, the activity range extrapolating unit 13 transmits, to the server 100, an acquisition request of area information relating to a monitoring target area 7 in the extrapolated activity range, acquires, from the server 100, the area information relating to a monitoring target area 7 in the activity range, and writes the area information into the second area information storing unit 12.

The presence sensing unit 51 senses whether or not the subject 3 is present in the report area 8 using area information stored in the second area information storing unit 12. Furthermore, when the presence sensing unit 51 senses that the subject 3 is within the report area 8, a sensing result is reported to the server 100.

In the present embodiment, since the presence or absence of the subject 3 in the report area 8 is sensed by the terminal apparatus 200, a reduction in latency of this sensing process can be achieved. In addition, since area information relating to a monitoring target area in the activity range of the subject 3 is stored in the second area information storing unit 12, the amount of information relating to area information is reduced and consumption of a memory resource of the terminal apparatus 200 can be suppressed. Furthermore, since only the monitoring target area 7 which is highly likely to be visited by the subject 3 is set as a processing target, a process of sensing whether or not the subject 3 is present in the report area 8 can be performed in an efficient manner.

### Twelfth Embodiment

In a twelfth embodiment, monitoring of the subject 3 is continued even when the subject 3 stays at a location outside of an activity range of the subject 3 in the eleventh embodiment. Moreover, in the present embodiment, similar components to the first to eleventh embodiments will be denoted by similar reference numerals and a description thereof will be omitted.

In the eleventh embodiment, since the second area information storing unit 12 only stores area information relating to a monitoring target area 7 within the activity range of the subject 3, the terminal apparatus 200 is unable to continue monitoring of the subject 3 when the subject 3 visits a location that is outside of the activity range of the subject 3. In consideration thereof, the present embodiment adopts the following configuration.

When the presence sensing unit 51 determines that the subject 3 has stayed outside of the activity range of the subject 3 from position information sensed by the position information sensing unit 4, the presence sensing unit 51 acquires, from the server 100, area information relating to a monitoring target area 7 positioned within a certain range including the sensed position information. In addition, using the acquired area information, the presence sensing unit 51 senses whether or not the subject 3 is present in the report area 8. In this case, as the certain range, for example, a region of a size over which the subject 3 can travel within a prescribed period of time (for example, 30 minutes, 1 hour, or 2 hours) on foot, on a bicycle, or by a car can be applied.

Moreover, when the subject 3 further stays outside of a certain range after area information relating to the certain range is acquired from the server 100, the presence sensing unit 51 may acquire area information relating to a certain range that is centered on the position where the subject 3 has further stayed. In other words, the presence sensing unit 51 may acquire new area information from the server 100 every time the subject 3 can no longer be monitored by the area information that the terminal apparatus 200 has.

As described above, according to the present embodiment, monitoring of the subject 3 can be continued and appropriate report can be performed to the subject 3 even when the subject 3 has stayed at a location that is outside of the activity range of the subject 3.

### Thirteenth Embodiment

In a thirteenth embodiment, the presence sensing unit 51 varies a size of the report area 8 in accordance with area information and state information. For example, when the state information stored by the state information storing unit 2 represents a trend of recent insufficient calorie consumption of the subject 3, the presence sensing unit 51 may expand a range of the report area 8 of the fitness club. Accordingly, the possibility of a message prompting the subject 3 to work out at the fitness club being reported to the subject 3 increases and a trend of recent decreasing calorie consumption can be improved.

In addition, when the weather on the day is bad, a range of the report area 8 of an area of a park may be reduced. Moreover, for example, the presence sensing unit 51 may access a weather forecast server that provides weather forecasts to acquire information on the weather of the location where the subject 3 is staying. Accordingly, the possibility of a message prompting the subject 3 to exercise in the park being reported to the subject 3 even when the weather is bad decreases and a situation where the subject 3 is discouraged from continuing the diet can be avoided.

As a method of varying sizes, for example, in the example of calorie consumption described earlier, a mode may be adopted in which an amount of decrease of calorie consumption over the past three days is obtained, and the greater the amount of decrease, the greater the range of the report area 8 is increased in stages or continuously. In addition, in the example of weather described above, for example, a mode may be adopted in which, when the weather at the location where the subject 3 is staying is cloudy, the range of the report area 8 is reduced by one stage as compared to sunny weather, and when the weather is rain, the range of the report area 8 is reduced by two stages as compared to sunny weather. Alternatively, a mode may be adopted in which the range of the report area 8 is reduced in stages or continuously as the probability of precipitation at the location where the subject 3 is staying increases.

According to the present embodiment, a range of the report area 8 can be varied in accordance with a relationship between a state of the subject 3 and the monitoring target area 7 where the subject 3 stays or a relationship between a state of the subject 3 and a peripheral state of the monitoring target area 7 where the subject 3 stays.

### Fourteenth Embodiment

An information reporting system according to a fourteenth embodiment provides a service for improving a financial state to the subject 3. Moreover, in the present embodiment, similar components to the first to thirteenth embodiments will be denoted by similar reference numerals and a description thereof will be omitted. In addition, in the present embodiment, either FIG. 2 or FIG. 8 may be adopted as an overall configuration of an information reporting system.

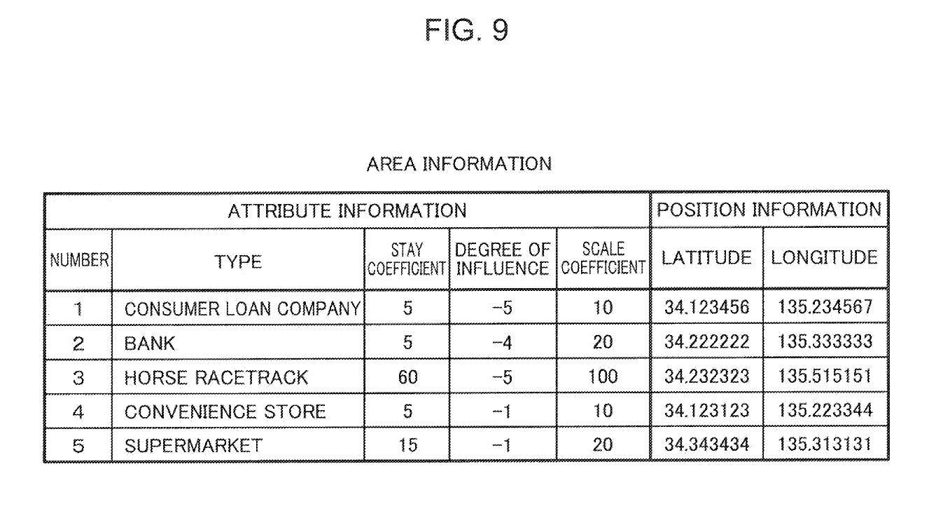

FIG. 9 is a diagram showing an example of data configuration of area information according to the fourteenth embodiment. While area information shown in FIG. 9 has almost the same data configuration as the area information shown in FIG. 4, the area information shown in FIG. 9 differs from the area information shown in FIG. 4 in that degrees of influence are registered instead of diet coefficients and in the locations that are registered. In the area information shown in FIG. 9, as the monitoring target areas 7, locations at which the subject 3 spends money such as consumer loan companies, banks, horse racetracks, convenience stores, and supermarkets are registered.

In addition, in the present embodiment, the presence sensing unit 51 uses the area information shown in FIG. 9 and the method described in the second embodiment to determine whether or not the subject 3 is present in the report area 8.

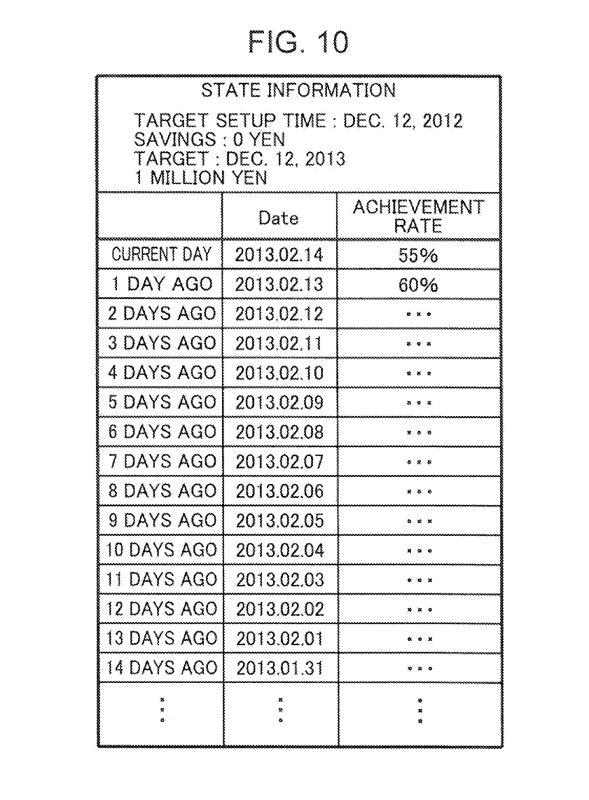

FIG. 10 is a diagram showing an example of data configuration of state information according to the fourteenth embodiment. While the state information shown in FIG. 10 has almost the same data configuration as the state information shown in FIG. 5, the state information shown in FIG. 10 differs from the state information shown in FIG. 5 in that achievement rate is registered instead of weight and that activity amount, weather, and patterns are not registered. The example presented in FIG. 10 shows that target setup had been performed on Dec. 12, 2012 and a target of increasing savings to one million yen in one year by Dec. 12, 2013 is registered. In other words, in the present embodiment, a household financial state of the subject 3 is adopted as state information. Specifically, in the example shown in FIG. 10, an achievement rate is adopted as state information.

An achievement rate refers to a ratio of actual savings to savings that should be achieved on the day. In the example shown in FIG. 10, in order to save one million yen in one year, assuming that the savings upon target setup is zero yen, savings required per day is 2800 yen (=1,000,000 yen/365 days). Therefore, savings to be achieved by Feb. 14, 2013 that is the current day is 182,000 yen (=65 days·2800 yen/day). On the other hand, let us assume that the savings as of Feb. 14, 2013 is 100,100 yen. In this case, the achievement rate can be calculated as 55% (=100,100 yen/182,000 yen).

In the present embodiment, the extrapolating unit 52 extrapolates whether the monitoring target area 7 in the report area 8 sensed by the presence sensing unit 51 is to have a positive influence or a negative influence on a state of the subject 3 based on a relationship between the achievement rate calculated as described above and a degree of influence of the monitoring target area 7.

In this case, for example, the extrapolating unit 52 may determine the state of the subject 3 to be a positive state when the achievement rate is equal to or greater than 110%, a normal state when the achievement rate is equal to or greater than 90% and less than 110%, and a negative state when the achievement rate is less than 90%.

In addition, when the subject 3 is in a negative state and the degree of influence of the monitoring target area 7 has a negative value, the extrapolating unit 52 may extrapolate that the monitoring target area 7 is to have a negative influence on the state of the subject 3. Furthermore, when the subject 3 is in a negative state and the degree of influence of the monitoring target area 7 has a positive value, the extrapolating unit 52 may extrapolate that the monitoring target area 7 is to have a positive influence on the state of the subject 3. Moreover, when the subject 3 is in a negative state and the degree of influence of the monitoring target area 7 has a value of 0, the extrapolating unit 52 may extrapolate that the monitoring target area 7 is to have no influence on the state of the subject 3. In addition, when the subject 3 is in a positive state, the extrapolating unit 52 may extrapolate that the monitoring target area 7 is to have a positive influence or a negative influence on the state of the subject 3 regardless of the value assumed by the degree of influence of the monitoring target area 7. Furthermore, when the extrapolating unit 52 extrapolates that the monitoring target area 7 is to have a negative influence on the state of the subject 3, the reporting unit 53 may report a warning message such as “You are trying to save money. You should keep a tight hold on the purse strings.” to the subject 3.

In addition, when the extrapolating unit 52 extrapolates that the monitoring target area 7 is to have a positive influence on the state of the subject 3, the reporting unit 53 may report a message such as “Your savings are more than adequate. You could spend some money today and feel good about it. Mindful of spending too much.” to the subject 3.

As described above, according to the present embodiment, since a warning message is reported to the subject 3 when the subject 3 stays at the monitoring target area 7 that poses an expenditure risk depending on a financial state of the subject 3, improvement and suppression of deterioration of the financial state can be achieved.

Moreover, the present embodiment may adopt the following modes.

(1) While a long term weight loss rate is used as a parameter of a degree of long-term progress in the second embodiment, this is simply an example and, for example, an amount of long term weight loss, the number of elapsed days, a long term weight loss rate, and the like may be used in combination.

In addition, for example, while a weight variation over three days is adopted as a parameter of a degree of short-term progress, other parameters such as a daily weight variation may be used instead. Furthermore, as the coefficients such as the diet state, the diet coefficient, and the stay coefficient, coefficients individually set for each subject 3 may be adopted or coefficients set to a value common to all subjects 3 may be adopted. In addition, while a reporting value is determined using the table shown in FIG. 7 based on a relationship between a diet state and the diet coefficient, the reporting value may be determined using other methods.

(2) As variations of the reporting to the subject 3 who is on a diet, for example, the following can be adopted. For example, the reporting unit 53 may report a message praising the subject 3 when the subject 3 uses the stairs, and may report a warning message to the subject 3 when the subject 3 uses the elevator or the escalator.

In addition, for example, the reporting unit 53 may report a message praising the subject 3 when the subject 3 walks on a hilly road with steep climbs and descents and may report a warning message to the subject 3 when the subject 3 walks on flat terrain.

Furthermore, for example, the reporting unit 53 may report a message praising the subject 3 when the subject 3 gets off the train one station before the nearest station to his/her home and walks home.

(3) While examples in which services with respect to dieting and financial state are provided to the subject 3 have been presented in the embodiments described above, alternatively, for example, a service with respect to health may be provided to the subject 3. In this case, for example, a health state, personal medical history, or physical constitution of the subject 3 may be adopted as state information, and the reporting unit 53 may report a warning message when the subject 3 visits a location that is detrimental to his/her health. For example, a mode may be adopted where, in a case where the subject 3 has asthma, a warning message is reported to the subject 3 when the subject 3 visits a location with intensely polluted air. Alternatively, a mode may be adopted where, in a case where the subject 3 has an allergy, e.g., cold urticarial, a warning message is reported to the subject 3 when the subject 3 visits a location where the temperature is low. Alternatively, a mode may be adopted where, in a case where the subject 3 is allergic to pollen or wasps, a warning message is reported to the subject 3 when the subject 3 visits a location where pollen or wasps are present in abundance.

(4) While the subject 3 and the third party 6 are adopted as report destinations in the embodiments described above, alternatively, for example, a mode may be adopted where an unspecified large number of persons are reported. As a method of reporting an unspecified large number of persons, for example, a mode may be adopted where a warning message is automatically uploaded to an SNS page of the subject 3.

(5) When the subject 3 repetitively visits the same monitoring target area 7 even after being repetitively warned, methods of warning may be varied so that warning severity increases. For example, when the subject 3 who is on a diet repetitively visits a hamburger shop even after being repetitively warned, the warning severity may be increased as the number of visits to the hamburger shop increases.

(6) While the position information sensing unit 4 senses a position of the subject 3 using a GPS signal, access point information, and base station information in the embodiments described above, alternatively, for example, the position of the subject 3 may be sensed by receiving position information transmitted from a position beacon.

### INDUSTRIAL APPLICABILITY

The present disclosure is useful for realizing cloud services that perform diet state management and financial balance state management of the subject 3.

1. An information reporting method in an information reporting system which reports information to a terminal apparatus through a network,
the information reporting method comprising:
sensing current position information relating to a subject;
sensing whether or not the subject is present in a report area including a monitoring target area, using area information in which is registered, in association with one another, position information relating to the monitoring target area and a degree of influence of the monitoring target area on a state of the subject and also using the sensed position information;
extrapolating a degree of influence of a monitoring target area in the sensed report area on a state of the subject, using state information indicating a state of the subject stored in a storage apparatus and the degree of influence; and
reporting information whose content corresponds to a result of the extrapolation to the terminal apparatus.

2. The information reporting method according to claim 1, wherein
an extrapolation is made as to whether or not a monitoring target area in the sensed report area has a negative influence on a state of the subject, and
the reporting is performed when a determination is made that the subject is not staying in the monitoring target area extrapolated to be an area that causes the negative influence.

3. The information reporting method according to claim 1, wherein
an extrapolation is made as to whether or not the monitoring target area in the sensed report area has a negative influence on a state of the subject, and
the reporting is performed when a determination is made that the subject is staying in the monitoring target area extrapolated so as to cause the negative influence.

4. The information reporting method according to claim 3, wherein when determination is made that the subject has stayed in the monitoring target area extrapolated to be an area that causes the negative influence, information whose content is modified in accordance with a period of stay is reported.

5. The information reporting method according to claim 1, wherein
an extrapolation is made as to whether or not the monitoring target area in the sensed report area has a positive influence on a state of the subject, and
the reporting is performed when a determination is made that the subject is staying in the monitoring target area extrapolated to be an area that causes the positive influence.

6. The information reporting method according to claim 5, wherein when determination is made that the subject has stayed in the monitoring target area extrapolate to be an area that causes the positive influence, information whose report content is modified in accordance with a period of stay is reported.

7. The information reporting method according to claim 2, wherein when determination is made that the subject has stayed in the monitoring target area extrapolated to be an area that causes the negative influence, information that causes discomfort in the subject is reported.

8. The information reporting method according to claim 2, wherein when determination is made that the subject has stayed in the monitoring target area extrapolated to be an area that causes the negative influence, information that is inappropriate for the monitoring target area is reported.

9. The information reporting method according to claim 1, wherein information for relaying at least one of sound, light, odor, vibration, and heat to the subject is reported.

10. The information reporting method according to claim 1, wherein the reporting is performed to the terminal apparatus of at least one of the subject and a third party specified in advance.

11. The information reporting method according to claim 1, wherein the terminal apparatus senses current position information relating to the subject and stores the current position information in a storage apparatus, extrapolates an activity range of the subject from the stored position information, acquires area information relating to the monitoring target area included in the extrapolated activity range from a server, and senses whether or not the subject is present in the report area, using the acquired area information.

12. The information reporting method according to claim 11, wherein when the terminal apparatus determines that the subject has stayed outside of the activity range based on the sensed position information, the terminal apparatus acquires the area information relating to the monitoring target area positioned within a certain range including the sensed position information from the server.

13. The information reporting method according to claim 1, wherein a size of the report area is determined based on the area information and the state information.

14. The information reporting method according to claim 1, wherein sensing of the position information is performed using at least one of a GPS signal, access point information of a wireless LAN, and base station information of a mobile phone communication network.

15. The information reporting method according to claim 1, wherein
the monitoring target area is a location where the subject spends money, and
the state information is a household financial state of the subject.

16. The information reporting method according to claim 1, wherein
the monitoring target area is a location that influences a diet state of the subject, and
the state information is the diet state of the subject.

17. The information reporting method according to claim 1, wherein the state information relating to the subject stored in the storage apparatus is used to calculate a degree of short-term progress and a degree of long-term progress with respect to the state of the subject relative to a target state, an overall state of the subject is calculated using the degree of long-term progress and the degree of short-term progress, and a reporting value in accordance with the overall state and the degree of influence is extrapolated as an influence of the monitoring target area on a state of the subject.

18. An information reporting system which reports information to a terminal apparatus through a network,
the information reporting system comprising:
a position information sensing unit that senses current position information relating to a subject;
a presence sensing unit that senses whether or not the subject is present in a report area including a monitoring target area, using area information in which is registered, in association with one another, position information relating to the monitoring target area and a degree of influence of the monitoring target area on a state of the subject and also using the sensed position information;
an extrapolating unit that extrapolates a degree of influence of a monitoring target area in the sensed report area on a state of the subject, using state information indicating a state of the subject stored in a storage apparatus and the degree of influence; and
a reporting unit that reports information whose report content corresponds to a result of the extrapolation to the terminal apparatus.
